(19) United States
(12) Patent Application Publication
(10) Pub. No.: US 2013/0031011 A1
(43) Pub. Date: Jan. 31, 2013

(54) Building Rating System

(71) Applicants: Peng Lee, Oxford, MS (US); Kevin Seddon, Oxford, MS (US)

(72) Inventors: Peng Lee, Oxford, MS (US); Kevin Seddon, Oxford, MS (US)

(73) Assignee: KPS,LLC, Oxford, MS (US)

(21) Appl. No.: 13/232,104

(22) Filed: Sep. 14, 2011

Related U.S. Application Data
(60) Provisional application No. 61/403,617, filed on Sep. 20, 2010.

(51) Int. Cl. G06Q 50/16

(52) U.S. Cl. 705/306

(57) ABSTRACT

Information contained in the building/property reports and assessments are long, terminology is difficult to understand and content is hard to access or manipulate. Traditional approaches to building inspection and assessment of value are insufficient and do not encompass all factors now relevant. These additional factors include measurements, testing and inspection of a building's energy efficiency and environmental health/safety as it relates to inhabitants of the property. This new information, plus the traditional inspection information and appraisal data will provide a complete valuation of a home or building and its overall impact on inhabitants. All data can be collected, assigned numerical values, and a weighted scoring system can be developed that is accurate, understandable and accessible. The information, scores and indexes can be stored, managed, presented and shared in a fast, unique and relevant manner for stakeholders to see and use to benefit themselves and the marketplace.

This application claims the benefit of U.S. Provisional Application No. 61/403,617 filed Sep. 20, 2010, under 35 U.S.C. Section 119(e) (hereby specifically incorporated by reference in its entirety).

### REFERENCES CITED

U.S. Patent Documents

| | | |
|---|---|---|
| 61/403,617 | Sep. 20, 2010 | Lee |
| 7,369,955 | May 6, 2008 | Lee |
| 7,445,377 | Nov. 4, 2008 | Lee |
| 7,385,483 | Jun. 10, 2008 | Lee |
| 7,434,990 | Oct. 14, 2008 | Lee |
| 7,271,706 | Sep. 18, 2007 | Lee |
| 7,429,928 | Sep. 30, 2008 | Lee |
| 7,822,691 | Oct. 26, 2010 | Kuo |
| 7,983,925 | Jul. 19, 2011 | Kuo |
| 6,401,070 | Jun. 4, 2002 | McManus, et al. |
| 7,933,927 | Apr. 26, 2011 | Dee, et al. |
| 7,664,574 | Feb. 16, 2010 | Imhof, et al. |
| 7,756,804 | Jul. 13, 2010 | Bloom, et al. |
| 5,516,309 | May 1996 | Sayer et al. |
| 6,356,897 | March 2002 | Gusack |
| 6,629,095 | September 2003 | Wagstaff et al. |
| 6,677,963 | January 2004 | Mani et al. |
| 6,768,982 | July 2004 | Collins et al. |
| 6,813,615 | November 2004 | Colasanti et al. |
| 6,912,533 | June 2005 | Hornick |
| 6,920,458 | July 2005 | Chu et al. |
| 6,941,287 | September 2005 | Vaidyanathan et al. |
| 6,954,758 | October 2005 | O'Flaherty |
| 7,096,206 | August 2006 | Hitt |
| 7,152,092 | December 2006 | Beams et al. |
| 7,280,991 | October 2007 | Beams et al. |
| 2002/0080169 | June 2002 | Diederiks |
| 2003/0171829 | September 2003 | Fisher et al. |
| 5,611,059 | Mar. 11, 1997 | Benton, et al. |

### OTHER REFERENCES

“ASHI Standards of Practice”, American Society of Home Inspectors
“NAHI Standards of Practice”, National Association of Home Inspectors
“Inter NACHI Standard of Practice”, International Association of Certified Home Inspectors.
FNC Inc. provides an appraisal score to help lenders evaluate how closely an appraisal conforms to more than 600 generally accepted appraisal rules based on the USPAP and Fannie Mae and Freddie Mac guidelines.
DOE Home energy score, http://www1.eere.energy.gov/buildings/homeenergyscore/Argentino, “100's of Tips on Saving Energy and Money at Home”
(www.mississauga4sale.com/newsletter/energy.sub.--saving.sub.--tips.htm), Jul. 16, 1996.
“Home Energy Audit”, www.montgomerycountymd.gov/mc/services/dep/Energy/audit.htm, Jan. 12, 1999.
“Infrared Energy Audit”, Predictive Maintenance Co.,
www.predictive-maintenance.com/energy.html, Jun. 27, 2001.
“Checklist for Energy Efficiency in Buildings”,
www.arch.hku.hk/.about.cmhui/teach/SBT/check.pdf, Oct. 9, 1999.

### FIELD OF INVENTION

This invention relates to the overall valuation and information-sharing in regard to commercial and residential buildings and crosses over and interrelates the fields of building inspection, assessment/appraisal, maintenance, real estate and insurance. The invention is comprised of a system and method for obtaining information about a building that affects its overall value which are derived from multiple perspectives. Evaluating said information and developing a scoring system for components, areas of concern and importance of the building, estimating repair, retrofit costs and remediation costs and then estimating repair, retrofit and remediation return on investment, and creating databases for the information so that it can be stored, managed, shared and used in various forms and formats including but not limited to a web “cloud-based” networking site for home or building owners, mortgage lenders, insurers, potential home or building purchasers and others that have a stake or future stake in the value of the property.

### BACKGROUND OF THE INVENTION

Assessing the value of a property or building is an important part of real estate transactions. Valuing a property and communicating the information obtained through inspection is an important part of buying and selling real estate. Lenders require accurate information in order to reduce risk when lending against property used as collateral, and they need to assess the information quickly because any delay in lending would result in a delay in interest and payments. There are currently many specific types of inspections utilized to gather different aspects of information about a building or property.

### BACKGROUND ART

personal credit score assists lenders in evaluating a borrower's financial ability to repay a home or building loan. However, this credit score is not a sufficient source of information for the lender because it does not provide any information about the condition (building components, energy efficiency, indoor environmental quality and safety.) of the building. A comprehensive evaluation of the building, which is in fact the collateral for the lender's loan, and a score that will encompass all the important value factors of the building is needed. In addition, an interactive means for all stakeholders (borrower, lender, insurance provider etc.) to list, effectively manage, easily access and update current building data change its “score” is essential.

FNC Inc., a company that provides an appraisal score to help lenders evaluate how closely an appraisal conforms to more than 600 generally accepted appraisal rules based on the USPAP, Fannie Mae and Freddie Mac guidelines. However, the data in the FNC appraisal score is not complete because it does not provide any information about the condition of the building as we have stated including the actual building components, energy efficiency, indoor environmental quality, safety and the impact the building can have on the health/safety of its inhabitants. All of these factors must also be included in any value assessment.

The Department of Energy (DOE) provides a score based on energy efficiency data gathered from a building. However, it is also not complete for the same reasons indicated previously. This approach is one-dimensional and does not provide a sufficient rating for all stakeholders to ascertain the actual overall value of a structure. In addition, the DOE score is not satisfactory as a baseline even for energy efficiency because the inspection does not include the use of infrared technology to ascertain the energy integrity of hidden areas of a building. A visual inspection of any kind can only account for roughly 33% of a building.

The information contained in a simple building inspection report outlines the general working condition and safety of a building's structural and mechanical components. This report is by nature a long document, although a summary is sometimes provided. Although its thoroughness is important, its length and its building and construction trade language and descriptions are an obstacle for lenders because it is difficult for them to understand. But, this is but one reason which prevents it from being a quick and valued reference for lenders. In addition, the vast majority of building inspections (which are not required by law) do not provide valuable information that is now incredibly important and intrinsic to the value of a home or building. These additional factors include specific measurement, testing and inspection of a home or building's energy efficiency and environmental and health of its inhabitants safety. This new information, plus the traditional inspection information and appraisal information provide a complete valuation of the home or building and its overall impact on its inhabitants and others that might enter the building. However, collecting all the data described, assigning numerical values and developing a weighted scoring system that is accurate, understandable and accessible is critical. Additionally, storing, managing, presenting and sharing this information for all stakeholders to “see” and “use” to benefit themselves and the marketplace is also critical.

### SUMMARY OF THE INVENTION

A series of procedures, protocols and calculations, that if performed as required or combined with existing data, will produce a unique outcome in the form of quantitative scores and indexes for major elements of interest of a building. There are several components of the process but generally they are as follows: The relevant inspection data is collected or acquired in soft or hard copy form, or an inspector gathers data utilizing inspection report software and collects data in four general areas of interst, they are: (1) The building components of a building, e.g. home/real estate inspection building data (2) environmental issues concerning the building (e.g. moisture intrusion, water damage, mold, pest, rodent, wood destroying insect, noise, radon, EMF pollution and etc.), (3) building safety, and (4) energy efficiency issues concerning the building. All the data collected in each of the four (4) areas would be assigned a “score” based on specific rules described herein, and the information about each of the many components within the structure, collected during the inspections and their scores, is stored in a database. Additional relevent data that can be used to assess the value of the building may also be included within the four areas of interest or additional areas may be added. For example, the use of infrared technology, which allows hidden structural issues, moisture issues, energy issues, air quality issues and potentially other “value related” issues to be observed, may be encompassed in the four areas of interest OR it may be designated as a seperate area of interest.

From the scores assigned to each of the many components inspected, a general or average score, such as from 1 to 10, is assigned to each of the three areas of interest. One end of the scoring spectrum is a negative or considered bad, and the other positive or good. The average scores of each are uploaded to four (4) distinct yet interactive databases. Additionally, a fifth (5th) database stores Appraisal Score information. Therefore, the five (5) databases with all relevent information about the structure, its components, areas of interest, individual scores and average scores are identified as follows:
HouseScore Calculation (Building Components)
HealthyHome/Environmental Score Calculation
Efficiency and Energy Score Calculation
Safety Score Calculation
Appraisal Score

### BRIEF DESCRIPTION OF THE DRAWINGS

FIG. 1 represents the distributed embodiment of the present invention.

FIG. 2 is a data flow diagram which depicts the flow of data between major processes in the present system.

### DESCRIPTION OF THE INVENTION

### I. Distribution Embodiment

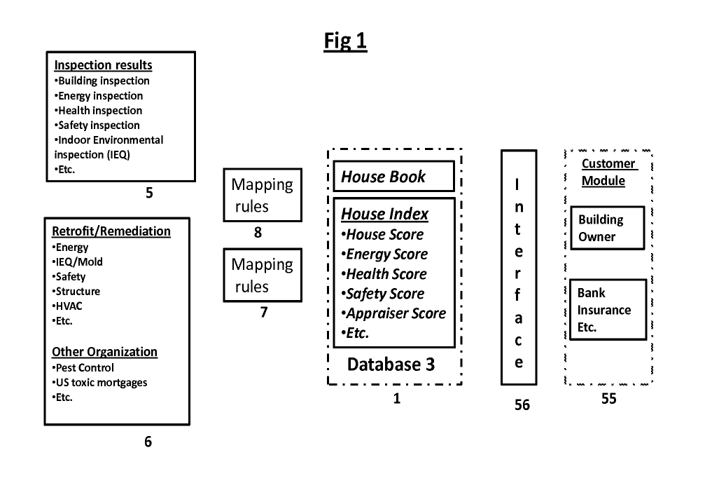

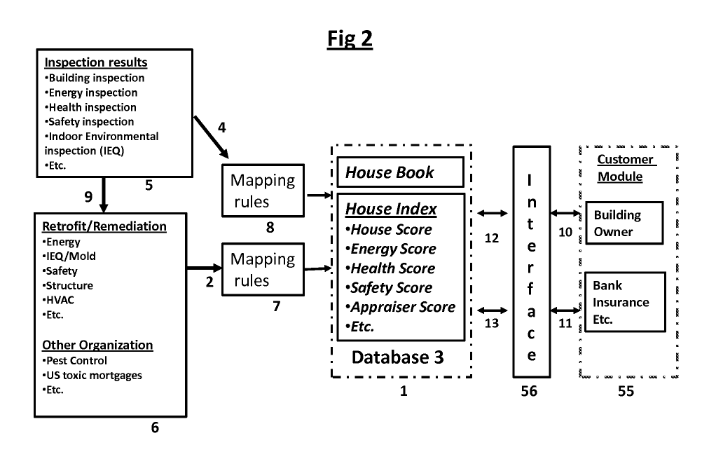

Now refer to FIG. 1, the present invention uses a distributed architecture in which a user database 3 is contemplated to be available in multiple forms including Database, web sites, web forums or web communities and/or “closed” business web communities. The user database 3 is maintained with mapping rules 8 as shown herein as table 1-31 or with some like kind of numerical scoring system and formula assignment. A table is a portion of database that groups records together, such as, but not limited to, user table, user rights table and/or a dictionary table with defining drop down boxes or menus. Now refer to FIG. 2, the user application 5 is the functional portion of the invention where the user enters or uploads information manually (inspection results/data), the system enters information electronically, the user views information, and the system outputs information electronically. All of this information is accessed from the user database 3 via the communication pathway 4. Customers 55, such as the building owner, also may gain access to database 3 (which includes the house score, house index and HouseBook or HomeBook data which will include inspection data and perhaps other relevant information that has been collected and stored by inspectors, HouseBook or HomeBook employees, vendors, advertisers, business partners and/or those designated as “Neighbors” by the building owner), through interface 56, communication pathway 10 and 12. Bank, insurance and other interested parties 55 will request information to database 3, including the house score and house index and other information which is deemed appropriate, through interface 56 communication pathway 11 and 13. Multiple users may be supported by the user support site 1. User database 3 can be and normally would be located at another location designated by the user. This user database 3 can be maintained remotely through a user support site 1. Similarly, user application 5 may also be located in another location designated by the user. Similarly, any number of other user databases 6 and other mapping rules 7 may be installed and maintained from one common user support site 1 via a communication path 2. Database 6 may be information concerning the retrofit and/or upgrade of the building. Any retrofit or upgrade can potentially help improve the score and index of the building. Database 6 can also be information from other organizations.

Customer Module: The application Module 55 is the part of the system that allows customers to interact with the system, for example to approve or view audited information. More specifically, various tools are provided to accomplish the functions of the system. These tools include: “Log In”, The application Module 55 is designed to allow customers different access to processes, information, dialogue, reports etc. depending on their access rights. Therefore, all users must have a valid login username and password to enter the system. This username and password does not have to, but it can be authenticated with another external system using a protocol such as Lightweight Directory Access Protocol (LDAP).

### II. The Rules for Building Components of a Home, E.G. Home/Real Estate Inspection Building Data are Shown in Tables 1-8. (Score: −10 is Bad; 10 is Good)

TABLE 1
Exterior

```
Surface Water
  Toward house -- 1
  Level grade -- 5
  Away from house -- 10
Fire Hazard
  Wood/brush/tree next to house -- 1
  Not next to house -- 10
Exterior Wall Condition
  Good -- 10
  Average -- 5
  Poor -- 1
Others
  Good -- 10
  Average -- 5
  Poor -- 1
```

TABLE 2
Interior

```
Wall Condition
          Good -- 10
          Average -- 5
          Poor -- 1
Floor Condition
          Good -- 10
          Average -- 5
          Poor -- 1
Ceiling Condition
          Good -- 10
          Average -- 5
          Poor -- 1
Ceiling Insulation
          Good (10″ and up)) -- 10
          Average (6″ to 10″) -- 5
          Poor (less than 6″) -- 1
          No insulation -- −10
Structure Integrity
          Good -- 10
          Average -- 5
          Poor -- 1
          Major structure damage -- −10
Door Condition
          Good -- 10
          Average -- 5
          Poor -- 1
Windows Type
          Single Pane -- 1
          Double Pane -- 5
          Double Pane & Low E -- 10
Window Condition
          Good -- 10
          Average -- 5
          Poor -- 1
Home Security System
          Yes -- 10
          No -- 1
          Not Functional -- 1
```

TABLE 3
Roof

New Condition -- 10
Average -- 5
Old -- 2
Leaking -- −10 (issue safety/health warning)

TABLE 4
Electrical

Mostly Correct -- 10
Some Small Issues -- 7
Some Larger Issues -- 3
Major Issues -- −10 (issue safety warning)

TABLE 5
HVAC

Less than 5 years old and working -- 10
More than 5 years old and working -- 7
Not working -- −10

TABLE 6
Appliance

All Items working -- 10
One or two items not working -- 5
Most than half Items not working -- 0

TABLE 7
Pest (Interior)

```
Mice
          Active -- −10 (issue health warning)
          Evidence only -- 1
          None -- 10
Termite
          Active -- −10 (issue WDI warning)
          Evidence/Mud tube only -- 1
          None -- 10
Roach problem
          Active -- −10 (issue health warning)
          Evidence only -- 1
          None -- 10
```

TABLE 8
Infrared Scan (IR)

```
*Hidden Problems
          Missing Insulation
                    Less than 5% -- 4
                    More than 5% -- 1
                    Small area/Normal -- 8
                    None -- 10
          Electrical hot spots
                    Yes -- −10 (issue safety warning)
                    No -- 1
          Water Leaks
                    Roof/Pipe
                              Yes -- 1 (issue health warning)
                              No -- 10
          Water Condensation
                    HVAC
                              Yes -- 1 (issue health warning)
                              No -- 10
                    Wall, Bathroom
                              Yes -- 1 (issue health warning)
                              No -- 10
          Pest
                    Evidence of Mice/Termite Tunnel
                              Many -- 1
                              Some -- 5
                              No -- 10
                    Active Mice/Termite
                              Yes -- −10 (issue health warning)
                              No - 10
```

III. Engery Issues Rules Concerneing the Home should be Collected are Shown in Tables 9-15.

TABLE 9
Energy

```
BPI Inspection
        Comply with BPI -- +50
        No -- 0
Energy Star/Green Building/Leed
        Comply with Energy Star -- +50
        No -- 0
HomeSafe's SIRI Energy Inspection
          Visual with the help of IR scan
Ceiling Insulation
          Good (10″ and up)) -- 10
          Average (6″ to 10″) -- 5
          Poor (less than 6″) -- 1
          No insulation -- −10
Wall insulation
          R 19 and higher -- 10
          R11 -- 5
          No Insulation -- −10
```

TABLE 10
Infrared Scan (IR)

```
*Hidden Problems
          Ceiling
                    Missing Insulation - 1% to 5% -- 4
                    Missing Insulation - more than 5% -- 1
                    Missing Insulation - Small area -- 8
                    No Insulation Missing - 10
          Wall
                    Missing Insulation - 1% to 5% -- 4
                    Missing Insulation - more than 5% -- 1
                    Missing Insulation - Small area -- 8
                    No Insulation Missing - 10
          Leakage through cracks
                    None -- 10
                    Some -- 5
                    Many - 0
```

TABLE 11
HVAC

```
Data collection by inspector
          Size: Total tonage (Size)
          SEER or EER number
          Year
          Furnace size in Btu(Fsize)
          Furnace Efficiency in % (Feff)
          If SEER/EER less than 13 go to HVAC
Energy saving calculation
          HVAC (cooling) energy saving calculation per year in Btu (if
          homeowner upgrade to high efficiency AC system has SEER
          15 efficiency) =
          (1 − Old seer/15) × (Size × 1,2000 Btu) × (ΔT × Tcool)
          *ΔT: Average temp. diff. between indoor & outdoor for that
          location
          *Tcool: Total hour of cooling usage per year for that
          location
          *Size: Ton
          HVAC (heating) energy saving calculation per year in Btu (if
          homeowner upgrade to high efficiency furnace has 94%
          efficiency) =
          (1 − Feff/94) × (Fsize) × (ΔT × Theat)
          *ΔT: Average temp. diff. between indoor & outdoor for that
          location
          *Theat: Total hour of heating usage per year for that
          location
          *Feff: Old furnace efficiency
          *Fsize: Size of furnace(Btu)
```

TABLE 12
Light

```
  Incondesent light -- 0
  Florescent T12 -- 5
  Florescent T8 -- 10
Data collection by inspector
          Total # of light fixtures (F#)
          Total power consumption (Twatt)
            (Twatt = F# × light wattage)
          Total # of hrs. used per day (Thr)
          Total # of days used per yr. (Tday)
          If not T8 GoTo Light energy saving
            calculation
Light energy saving Calculation in kWh (if homeowner upgrade to T8
florescent light that provides up to 70% saving) =
Twatt × Thr × Tday × 0.7
```

TABLE 13
Renewable Energy

```
Solar Hot Water Heater
        Yes -- 10
        No -- 0
Solar photovotac
        Yes -- 10
        No -- 0
GeoThermal
        Yes -- 10
        No -- 0
Wind Power
        Yes -- 10
        No -- 0
Others
        Yes -- 10
        No -- 0
```

TABLE 14
Building Shell energy deficiency

```
Data collection by inspector
            Leakage (If BPI use BPI, otherwise use .25 for new
            building and .75 for old building)
            Window
                    R value (Rwd):
                    Problem window square ft(Sfwd)
            Wall
                    R value (Rwl):
                    Problem wall square ft (Sfwl)
            Ceiling
                    R value(Rcl)
                    Problem ceiling square ft (Sfcl)
            Door
                    R value(Rdr)
                    Problem door square ft(Sfdr)
            Heated space
                    Total Sq. Ft. of heated building space (Sqft)
                    Floor to ceiling (Hfc)
Calculation of energy loss through building shell
(Energy move through wall/window/door/ceiling) =
1/R × ΔT × Thr × Total surface area
*ΔT: Average temp. diff. between indoor & outdoor for that location
*Thr: Total hour of heating and cooling usage per year for that location
*R: R value of that wall or window or door or ceiling
```

```
TABLE 15
Saving in Energy
Saving = Energy usage before up grade—Energy usage after up grade
Cooling - 12%
Light - 11%
Heating - 31%
Appliance - 17%
Use 11,000 Kwh/yr
  ~100 millions Btu/yr
  ~500 gal/car, yr

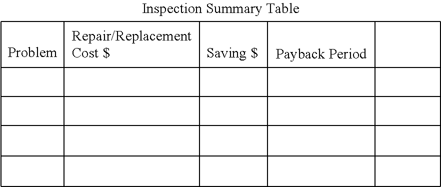

NOTE:
According to DOE average typical houshold energy usage in the whole U.S.
*Payback period or ROI = Total repair cost/Saving
```

### IV. Environmental (IEQ) Issues Rules Concerning the Home should be Collected are Shown in Tables 16-28

TABLE 16
Mold

```
visable
        Yes -- −10 (issue safety/health warning)
        No -- +10
Mold sample test result
        Positive -- −10 (issue safety/health warning)
        Negative -- +10
```

TABLE 17
Exhaust

```
Cook top (gas or electric) exhaust to outside
        Yes -- 10
        No -- 1 (issue safety/health warning if it is gas cook top)
Dryer exhaust to outside
        Yes - 10
        No -  1  (issue health warning)
All bath room exhaust to outside
        Yes - 10
        No -  1  (issue health warning)
All gas space heater exhaust to outside
        Yes - 10
        No --  1  (issue safety/health warning)
All gas/oil furnace exhaust to outside
        Yes -  10
        No -- −10 (issue safety/health warning)
Exhaust pipe condition
        Good -- 10
        Poor -- −10 (issue safety/health warning)
```

TABLE 18
Indoor Air Quality

```
Houshold cleaning products storage
        Outdoor -- 10
        Indoor -- 1
VOCs (Volatile organic compounds)
        Carbon Dioxide CO2 (Vco2)
                High -- −10 (issue safety/health warning)
                Low -- 10
        Relative Humidity RH (Vhrh)
                High -- −10 (issue safety/health warning)
                Low -- 10
        Carbon Monoxide CO (Vco)
                High -- −10 (issue safety/health warning)
                Low -- 10
        Formaldehyde (Vfoml)
                High -- −10 (issue safety/health warning)
                Low -- 10
        Radon (Vrdon)
                High -- −10 (issue safety/health warning)
                Low -- 10
```

TABLE 19
Noise Pollution

```
Indoor noise level
        Greater than 50 dB -- 1
        Less than 50 dB  -- 10
```

TABLE 20
Water Test

```
Chlorine level in supply water
        High -- 1 (issue safety/health warning)
        Low -- 10
```

TABLE 21
Chinese Dry Wall (Cdrywl)

```
Visual Indication
        Rusty Metal Parties
        Rusty Switches
        Rusty HVAC Coil
        Smell like rotten eggs
        IR Scan, Electrical Hot Spot
        Yes -- 1
        No -- 10
```

TABLE 22
EMF Pollution

```
Indoor magnetic field strength
        Low -- 10
        Average -- 5
        High -- 1
```

TABLE 23
Infrared Scan (IR)

```
Any water leaks (IRwrl)
        Yes -- −10 (issue safety/health warning)
        No --  10
Condensation (IRwcn)
        Yes -- −10 (issue safety/health warning)
        No --  10
Pest
        Rodent (IRpr)
                Evidence of Rodent Tunnel
                        Many -- 1
                        Some -- 5
                        None -- 10
                Active Rodent
                        Yes -- −10 (issue health warning)
                        None -- 10
        Wood Destroying Insect (WDI) (IRpw)
                Evidence of WDI Tunnel
                        Many -- 1
                        Some -- 5
                        None -- 10
                Active WDI
                        Yes --  −10 (issue WDI warning)
                        None -- 10
Electrical Hot Spot (IRec)
        Yes -- −10 (issue safety warning)
        No --  1
```

TABLE 24
HVAC

```
Oversize High RH (high RH - Hhrh)
        Positive --  1  (issue safety/health warning)
        Negative -- 10
No Fresh Air or the Make-up of Air for house(Hnfa)
        Positive --  1  (issue safety/health warning)
        Negative -- 10
No Make-up air for combustion(Hnmac)
        Positive -- −10  (issue safety/health warning)
        Negative -- 10
Exhaust not to outside (Hnex)
        Positive -- −10  (issue safety/health warning)
        Negative -- 10
Old and Very Inefficient system (Hvold)
        Positive -- −10
        Negative -- 10
```

TABLE 25
Radon Testing

High -- −10 (issue safety/health warning)
Low -- 10

TABLE 26
Asbestos Testing

Positive -- −10 (issue safety/health warning)
Negative -- 10

### V. Safety Issues Rules Concerning the Home should be Collected are Shown in Tables 27-28

TABLE 27
Safety Issues

```
Child
        Many -- −10 (issue safety warning)
        Few -- 5
        None -- 10
Senior
        Many -- −10 (issue safety warning)
        Few -- 5
        None -- 10
```

TABLE 28
Fire Issues

```
Any Fire risk
        Yes -- 1  (issue safety warning)
        No -- 10
Fire Exinguisher
        Yes -- 10
        No -- 1
```

### VI. Upload to Central Database

TABLE 29
Repair/Upgrade Estimate
IR (Infrared scan) repair/upgrade estimate

| | |
|---|---|
| IRwrl | $100 to $10,000 |
| IRwpl | $100 to $1,000 |
| IRwcn | $200 to $5,000 |
| IRpw | $500 to $5,000 |
| IRec | $100 to $500 |

HVAC repair/upgrade estimate

| | |
|---|---|
| Hhrh | $100 to 1,000 |
| Hnfa | $100 to $1,000 |
| Hnexh | $300 to $1,000 |
| Hvold | $1,500 to $2,500 per ton |
| Hnmac | $100 to $500 |

Mold repair/upgrade estimate
Remediation $50 to 50,000
VOC repair/upgrade estimate
Vco2 or Vfoml -- Covered by HVFAS
Vhrh -- Covered by Hhrh
Vco -- $100 to $1,000
Chinese made drywall repair/upgrade estimate
Drywall -- Replace all Chinese made drywall -- $10,000 to $50,000
Radon repair/upgrade estimate
Radon remediation -- $2,000 to $5,000
Noise repair/upgrade estimate
Noise remediation: $0 to $2,000
EMF repair/upgrade estimate
EMF remediation: $0 to $2,000
Water repair/upgrade estimate
lower chorine level: $200 to $1,000
Asbestos repair/upgrade estimate
Asbestos removal: $10,000 to $50,000

Output

| | | | | |
|---|---|---|---|---|
| | Repair/upgrade | | | Medical |
| Problem | Cost $ | Saving $ | Payback Period | Expenses |

(Note: All repair/upgrade costs listed below are just estimates. The NREL (National Residential Efficiency Measures Database) database provides a more comprehensive and accurate estimate of repair/upgrade costs.)
*Payback period = Total repair cost/Saving

TABLE 30
Medical Cost -- Medical Expense/Productivity Loss

```
Multiple types of inspections are performed on houses and buildings. The major types of
inspection include:
    General home or building inspection: Reports on whether major components of the home
    function correctly and if the building components are safe. Moisture intrusion issues are
    also addressed.
    Mold and IEQ inspection(s): Is often two separate reports with a mold test and report
    being the most common performed. Reports focus on the existence of mold and
    sometimes the type if warranted. IEQ or indoor environmental quality inspections focus
    on air contaminant issues including but not limited to mold. Also, air exchange issues and
    moisture issues are addressed. Sometimes but not always remediation recommendations
    are provided.
    Energy inspection: Reports on energy loss issues that are occurring within the building.
    Sometimes but not always how to correct the issues, retrofit the building and return on
    investment (ROI) are provided.
    Termite/Pest inspection: Reports on existence or likelihood of termites or other pests.
    Also, will recommend how to eradicate and then control infestations.
The above inspections are often very thorough and provide valuable information. And, although
in the case of energy inspections and IAQ inspections where cost of repair and ROI may be
provided, nowhere are the actual estimates in dollars that are paid by the inhabitants, insurers,
taxpayers and the government as a result of an unsafe environment - whether they are the result
of bad air quality or unsafe conditions. It is important that when assessing inspection data
collected and assigning scores/indexes, that the potential human medical costs be incorporated
into the formulas. The potential costs resulting from safety issues in a home and health problems
arising from indoor environmental issues can be obtained through data mining existing, reputable
resources that have proven to provide accurate information in the stated areas. It follows also
that if health costs to all parties is estimated, then correcting said environmental and safety issues
would result in real dollar savings and of course increase the value of the structure.
Potential Illnesses Due to Indoor Environmental Issues:
Allergy
Asthma
Lung Disease
Respiratory Diseases
Immune System Problems
Memory Loss
Chemical Poisoning
Disturbance of Daily Routine
Pest-related Diseases (Hunter Virus)
Degrading Quality of Life
Cost Information on Health and Safety Available Through:
NSF—National Science Foundation
New England Journal of Medicine
Environmental Protection Agency
Insurance Companies
```

TABLE 31
Calculation of “Score” and “House Index”

Resulting Score = (Tot. score of each section/Possible Max. tot. score of
each section) × 1000
(note: all resulting scores are normalized to the base of 1000 or any
base number)
Resulting House Index =
Sum or average of weighted or non-weighted scores taken individually
or in any of the below combination
HouseScore + Health Score or;
Energy Score + Appraisal Score + Healthy Score or;
House Score + Safety Score or;
Appraisal Score + Energy Score + House Score or;
Appraisal + healthy Score or;
Individual Score
e.g.
HouseScore assigns a weighting factor of 60%, and Health Score
assigns a weight of 40% Resulting House Index = (House
score × 0.6) + (Health score × 0.4)
(note: all resulting house indexes are normalized to the base of 1000 or
any base number)

The resulting scores and indexes with reporting or reporting summaries would be requested by clients and customers and other stakeholders in the real estate industry such as: home owners, home buyers, real estate agents, brokers, firms, appraisal firms and appraisors, financial institutions/lenders, insurance companies, agents, brokers, lawyers and city, state and federal governments, agencies.

A cost associated with repair, retrofit, remediation or healthcare will also be calculated to determine the lost revenue or cost associated with each area which is shown to be problematic. Also, a ROI or Return on Investment would be calculated in each category, e.g. The Building Components, Environmental, Energy, to determine the amount of time it may take to recoup the invesment made to correct the particular problem. This is reported to the user.

ROI or Return on Investment=Total repair Cost/Savings

This information is contemplated to be availabe in multiple forms including database, web sites, web forums, web communities, “closed” business web communities etc.

A fifth (5th) database stores appraisal score information and can be obtained via data mining. Modern data mining and data warehousing systems use complex algorithms to identify interesting patterns of information in the records of the underlying data source. The patterns of information frequently relate to groups of subjects. Knowledge about these interesting groups of subjects may be extracted or mined using agglomerative clustering; k-means clustering and/or various other knowledge extraction transformations. However, if the extracted knowledge is combined with information already available to the public, the combined information can in some instances be used to re-identify specific subjects within the groups.

Conventional k-anonymity and/or data generalization-based privacy systems are applied to the underlying records of the information source before the knowledge extraction and/or data mining transformations are performed. These conventional systems for protecting privacy are difficult to implement in a multi-party environment where only the clustered, agglomerated or extracted knowledge is available for sharing with a vendor. Moreover, these conventional systems for protecting privacy assume that all the relevant information is available simultaneously in a single location.

While this invention has been described in terms of a best mode for achieving this invention's objectives, it will be appreciated by those skilled in the art that variations may be accomplished in view of these teachings without deviating from the spirit or scope of the present invention.

1. A method to produce quantitative information scores and indexes of a building, comprising the steps of: collecting data of a building; cost of repair and ROI; applying mapping rules; and calculating algorithms of building data to produce scores and indexes.

2. The method of claim 1 wherein said data of building can be building components and related information of the building.

3. The method of claim 1 wherein said data of building can be safety related information of the building.

4. The method of claim 1 wherein said data of building can be energy related information of the building.

5. The method of claim 1 wherein said data of building can be indoor environmental (IEQ) related information of the building.

6. The method of claim 1 wherein said data of building can be health related information of the building.

7. The method of claim 1 wherein said final house index can be comprised of an individual score or multiple combination of scores (see table 31)

8. The method of claim 1 wherein said mapping rules and calculation algorithms can be modified based on requirements of customer.

9. A method wherein a scoring system and/or a final averaged index can be attributed to building components or house components in the areas of safety, energy, health, appraisal, indoor environmental (IEQ) and general working effectiveness—thus making the building's overall condition transparent to all stakeholders.

10. A method that allows the scoring and indexing of the value of a building based on its overall quality and livability, followed by an ability to alter said scores and/or indexes through various means and by various sources after remediation, retrofit, repair and/or upgrades have been implemented.

11. The method of claim 10 wherein said improvement and alteration of scores can be building safety related.

12. The method of claim 10 wherein said improvement and alteration can be energy efficiency related.

13. The method of claim 10 wherein said improvement and alteration can be IEQ related.

14. The method of claim 10 wherein said improvement and alteration can be health related.

15. The method of claim 10 wherein said improvement and alteration can be building component related.

16. A method that allows Bankers, Insurers or any designated/approved, interested party to obtain accurate information concerning the building.

17. The method of claim 16 wherein said information can be information, scores or indexes or both.

18. A method wherein a scoring system and/or a final averaged index can be attributed to building components or house components in the areas of safety, energy, health, appraisal, indoor environmental (IEQ) and general working effectiveness coupled with a method whereby all information about the components is collected and stored in databases and can be presented to and viewed in whole or in part, accessed in whole or in part, manipulated in whole or in part, deleted in whole and in part or added to by various parties whose access is monitored and controlled in whole or in part . . . .
